(19) United States
(12) Patent Application Publication
(10) Pub. No.: US 2023/0010084 A1
(43) Pub. Date: Jan. 12, 2023

(54) OPERATION MANAGEMENT METHOD, OPERATION MANAGEMENT APPARATUS, AND OPERATION MANAGEMENT SYSTEM

(71) Applicant: TOYOTA JIDOSHA KABUSHIKI KAISHA, Toyota-shi (JP)

(72) Inventors: Yu NAGATA, Chofu-shi (JP); Hiroshi HIGASHIDE, Nagoya-shi (JP)

(73) Assignee: TOYOTA JIDOSHA KABUSHIKI KAISHA, Toyota-shi (JP)

(21) Appl. No.: 17/811,114

(22) Filed: Jul. 7, 2022

(30) Foreign Application Priority Data
Jul. 7, 2021 (JP) 2021-112981

(51) Int. Cl. G01C 21/34; B60W 60/00; G06Q 10/06; G06Q 50/30

(52) U.S. Cl. CPC G01C 21/3415; B60W 60/00253; G06Q 10/06312; G06Q 50/30; B60W 2540/049; B60W 2420/42; B60W 2555/20; B60W 2540/01

(57) ABSTRACT

An operation management method according to an embodiment of the present disclosure is a method, performed by an operation management apparatus, for managing operation of a plurality of vehicles for passenger transportation. The operation management method includes selecting, upon detecting an occurrence of a predetermined event, one vehicle from among the plurality of vehicles each traveling a predetermined first route, determining a second route different from the first route, and switching a route traveled by the selected vehicle from the first route to the second route.

### CROSS-REFERENCE TO RELATED APPLICATION

This application claims priority to Japanese Patent Application No. 2021-112981, filed on Jul. 7, 2021, the entire contents of which are incorporated herein by reference.

### TECHNICAL FIELD

The present disclosure relates to an operation management method, an operation management apparatus, and an operation management system.

### BACKGROUND

A system for planning and changing the operation plans of a plurality of vehicles for transporting users has been proposed. For example, a vehicle operation system has been proposed for reconstructing an operation plan when a change occurs, due to unforeseen circumstances, in the maximum output value of the secondary battery in a plurality of electric vehicles capable of autonomous operation and the required output value required to travel a travel route. See, for example, Patent Literature (PTL) 1.

### CITATION LIST

### Patent Literature

PTL 1: JP 2020-013379 A

### SUMMARY

Conventional technology has improved the certainty that vehicles can be operated. From an economic and commercial point of view, however, vehicles that transport users should be able to transport users efficiently. For example, if many vehicles are operated when there are few users, the usage efficiency of the vehicles is reduced. On the other hand, many users may wish to use vehicles on a route other than the predetermined route.

It would be helpful to provide an operation management method, an operation management apparatus, and an operation management system that can improve the usage efficiency of vehicles.

An operation management method according to an embodiment of the present disclosure is an operation management method of a plurality of vehicles for passenger transportation performed by an operation management apparatus. The operation management method includes selecting, upon detecting an occurrence of a predetermined event, one vehicle from among the plurality of vehicles each traveling a predetermined first route, determining a second route different from the first route, and switching a route traveled by the selected vehicle from the first route to the second route.

An operation management apparatus according to an embodiment of the present disclosure is an operation management apparatus for a plurality of vehicles for passenger transportation. The operation management apparatus includes a controller configured to select, upon detecting an occurrence of a predetermined event, one vehicle from among the plurality of vehicles for passenger transportation each traveling a predetermined first route, determine a second route different from the first route, and switch a route traveled by the selected vehicle from the first route to the second route.

An operation management system according to an embodiment of the present disclosure includes a plurality of vehicles for passenger transportation and an operation management apparatus. The operation management apparatus is an operation management apparatus that manages the operation of the plurality of vehicles. The operation management apparatus includes a controller configured to select, upon detecting an occurrence of a predetermined event, one vehicle from among the plurality of vehicles each traveling a predetermined first route, determine a second route different from the first route, and switch a route traveled by the selected vehicle from the first route to the second route.

According to the present disclosure, the usage efficiency of vehicles can be improved.

### BRIEF DESCRIPTION OF THE DRAWINGS

In the accompanying drawings:

FIG. 1 is a diagram illustrating a schematic configuration of an operation management system according to an embodiment of the present disclosure;

FIG. 2 is a block diagram illustrating a schematic configuration of an operation management apparatus of FIG. 1;

FIG. 3 is a block diagram illustrating a schematic configuration of a vehicle of FIG. 1;

FIG. 4 is a diagram illustrating an example of a first route traveled by vehicles;

FIG. 5 is a diagram illustrating an example of a travel schedule for each vehicle traveling the first route;

FIG. 6 is a diagram illustrating a first example of a method for switching the route that a vehicle travels;

FIG. 7 is a diagram illustrating a second example of a method for switching the route that a vehicle travels;

FIG. 8 is a diagram illustrating a third example of a method for switching the route that a vehicle travels;

FIG. 9 is a diagram illustrating a fourth example of a method for switching the route that a vehicle travels;

FIG. 10 is a diagram illustrating an example of a travel schedule for vehicles recombined after an event has occurred;

FIG. 11 is a flowchart illustrating an example of procedures for operation management by an operation management apparatus; and

FIG. 12 is a flowchart illustrating an example of the process to detect event occurrence in FIG. 11.

### DETAILED DESCRIPTION

An embodiment of the present disclosure will be described below, with reference to the drawings.

(Overall Configuration of Operation Management System 1)

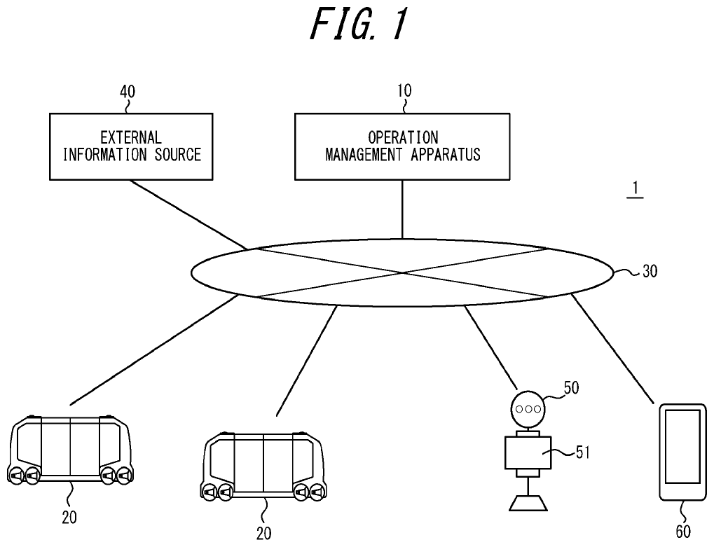

FIG. 1 is a diagram illustrating a schematic configuration of an operation management system 1 according to an embodiment of the present disclosure. The operation management system 1 includes an operation management apparatus 10 and a plurality of vehicles 20. The operation management apparatus 10 and the plurality of vehicles 20 are connected to a network 30 by wired or wireless communication means and are configured to communicate with each other. The operation management apparatus 10 is a computer that manages the operation of the vehicles 20. Each vehicle 20 is a vehicle capable of carrying a plurality of passengers, such as 5 to 50 passengers. The vehicle 20 may be a bus.

The operation management system 1 can provide a first service in which at least some of the vehicles 20 are used to travel along a predetermined fixed first route for a plurality of users to board and alight at predetermined stops 50. A typical shared-ride bus service that operates regularly on a defined route corresponds to the first service. The operation state of the vehicle 20 that provides the first service is referred to as the first mode. The operation management system 1 can also provide a second service in which at least some of the plurality of vehicles 20 are used to transport pre-registered users from a boarding location to an alighting location desired by the users in response to a request for vehicle dispatch. The second service is, in other words, an on-demand passenger transportation service. During the second service, the vehicle 20 can transport a plurality of users at the same time. The operation state of the vehicle 20 providing the second service is referred to as the second mode. The configurations of the operation management apparatus 10 and the vehicle 20 will be described below.

The operation management system 1 may be communicably connected via one or more networks 30 to an external information source 40, an information display apparatus 51 located at a stop 50 on the first route, and a portable information terminal 60 of a registered user. The external information source 40, the information display apparatus 51, and the portable information terminal 60 can transmit and receive information to and from the operation management apparatus 10 via a common network 30 or separate networks 30. The external information source 40 and the information display apparatus 51 may each be connected one-to-one with the operation management apparatus 10 by a direct communication line.

The network 30 includes public networks such as the Internet and dedicated networks such as a Virtual Private Network (VPN). The network 30 may be a plurality of interconnected networks, including a Local Area Network (LAN), a Wide Area Network (WAN), and a Metropolitan Area Network (MAN). The network 30 may include wired and wireless networks.

The external information source 40 is a computer operated by one or more external information service providers. External information services may, for example, include a service that analyzes and provides the distribution of people based on the location of mobile phones, a service that provides images of a city and the degree of congestion and the like analyzed from the images, a service that provides weather information, and a service that mines and provides useful information from information posted on a Social Network Service (SNS).

The stop 50 is a bus stop in a case in which the vehicle 20 is a bus. The information display apparatus 51 is disposed at the stop 50 and displays information such as the operation status of the vehicle 20 traveling the first route. A known display apparatus can be used as the information display apparatus 51, such as a Liquid Crystal Display (LCD), an organic Electro-Luminescent (EL) display, an inorganic EL display, and a Plasma Display Panel (PDP).

The portable information terminal 60 is a small information processing apparatus, such as a mobile phone, a smartphone, or a tablet terminal, that can be carried by a user. The portable information terminal 60 can communicate with the operation management apparatus 10 to acquire information on the operation status of the vehicles 20 traveling the first route and to transmit a request to use the on-demand passenger transportation service. An application corresponding to the service provided by the operation management system 1 can be installed on the portable information terminal 60.

(Configuration of Operation Management Apparatus)

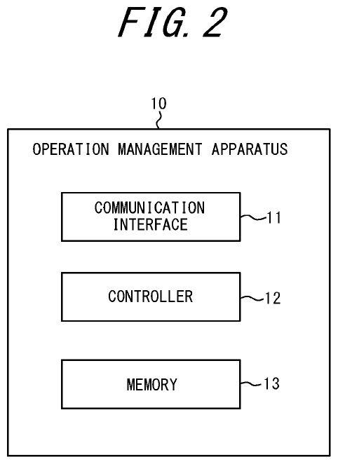

The operation management apparatus 10 is a computer, such as a personal computer, a workstation, or a general purpose computer. The operation management apparatus 10 acquires the current position of the plurality of vehicles 20 and controls the travel routes. The operation management apparatus 10 manages the operation of each vehicle 20 by transmitting the travel route to the vehicle 20. The operation management apparatus 10 can switch the vehicle 20 between the first mode and the second mode. As illustrated in FIG. 2, the operation management apparatus 10 includes a communication interface 11, a controller 12, and a memory 13.

The communication interface 11 includes a communication module and is configured to be capable of sending and receiving information to and from the vehicle 20, the external information source 40, the information display apparatus 51, and the portable information terminal 60 via the network 30. The communication interface 11 can perform processing, such as protocol processing pertaining to information transmission and receipt, modulation of transmitted signals, or demodulation of received signals.

The controller 12 controls the components included in the operation management apparatus 10. The controller 12 can transmit and receive various information to and from the vehicle 20 via the communication interface 11. The controller 12 can simultaneously manage the operation of the vehicles 20 in the first mode, which provide the first service, and the operation of the vehicles 20 in the second mode, which provide the second service. The controller 12 can determine a travel route and an operation schedule for each vehicle 20 and transmit the determined travel route and operation schedule to each vehicle 20. The controller 12 may include one or more processors. The controller 12 may include a variety of processors. Processors include general purpose processors that execute programmed functions by loading a specific program, and dedicated processors that are dedicated to specific processing.

The memory 13 stores programs executed by the controller 12, information required for processing executed by the controller 12, and information acquired as a result of execution by the controller 12. The memory 13 may include a semiconductor memory, a magnetic storage device, and/or an optical storage device. Semiconductor memory includes read only memory (ROM), random access memory (RAM), flash memory, and the like. RAM may include Dynamic Random Access Memory (DRAM) and Static Random Access Memory (SRAM). Magnetic storage devices include a hard disk and the like.

(Configuration of Vehicle)

The vehicle 20 in the present embodiment is an autonomous vehicle that travels a route, set by the operation management apparatus 10, in accordance with a travel schedule set by the operation management apparatus 10. Autonomous driving of the vehicle 20 may be implemented at any level from Level 1 to Level 5 as defined, for example, by the Society of Automotive Engineers (SAE). Without being limited to the exemplified definition, the autonomous driving may be performed based on other definitions. As the vehicle 20, a Battery Electric Vehicle (BEV) that runs on electric power and a gasoline automobile that runs on gasoline as fuel can be used. In the following description of the present embodiment, the vehicle 20 will be described as being a BEV.

The vehicle 20 is a form of vehicle such as a bus for passenger transportation. In the first mode for providing the first service, the vehicle 20 travels a predetermined first route for users to board and alight at stops 50 provided along the first route. After traveling one or more times along the corresponding predetermined route in accordance with the operation schedule, the vehicle 20 may sequentially switch with another vehicle 20 for battery recharging or the like.

In the second mode for providing the second service, the vehicle 20 may travel a second route different from the first route. The vehicle 20 can travel a route set by the operation management apparatus 10 as a second route after receipt of a request, from a user of the second service, for dispatch of a vehicle to travel from a boarding location to an alighting location desired by the user. In this case, the operation management apparatus 10 may receive a request for vehicle dispatch from a user and sequentially update the route traveled by the vehicle 20. That is, the second route may be a dynamic route that is updated over time. The operation management apparatus 10 may cause the vehicle 20 to travel by a different method. For example, the vehicle 20 may temporarily travel back and forth between two specific points to meet the transportation need for a location where many people gather. The two specific points are, for example, an event venue, such as a sports arena or concert hall, and a railway or other station. In this case, the operation management apparatus 10 sets a route connecting the two specific points as the second route. The second route may be determined to pass through a location with a high passenger transportation need as determined based on information including positional information for mobile phones, surveillance camera information, weather information, and/or information posted on an SNS.

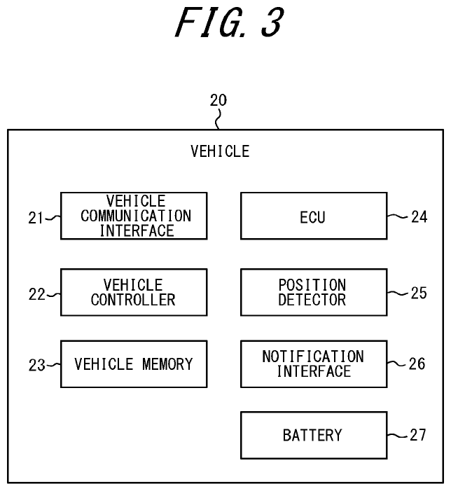

As in the example illustrated in FIG. 3, the vehicle 20 includes a vehicle communication interface 21, a vehicle controller 22, a vehicle memory 23, a plurality of Electronic Control Units (ECUs) 24 that control each component of the vehicle 20, a position detector 25, a notification interface 26, and a battery 27. The respective components of the vehicle 20 are communicably connected to each other via, for example, an in-vehicle network such as a Controller Area Network (CAN), or a dedicated line.

The vehicle communication interface 21 is configured to transmit and receive information to and from the operation management apparatus 10 via the network 30. The vehicle communication interface 21 may be, for example, an in-vehicle communication device. The vehicle communication interface 21 may include a communication module that connects to the network 30. The communication module may include a communication module compliant with mobile communication standards such as 4th Generation (4G) and 5th Generation (5G).

The vehicle controller 22 controls the components included in the vehicle 20. The vehicle controller 22 may include one or more processors. The vehicle controller 22 may include various processors, like the controller 12. The vehicle controller 22 controls the ECUs 24 to drive the vehicle 20 according to the route acquired from the operation management apparatus 10.

The vehicle memory 23 stores programs executed by the vehicle controller 22 and information required for processing executed by the vehicle controller 22. Like the memory 13, the vehicle memory 23 may include a semiconductor memory, a magnetic storage device, and/or an optical storage device. The vehicle memory 23 can store travel routes of the vehicle 20 and map information.

The ECUs 24 are Electronic Control Units (ECUs) that control the components in the vehicle 20. The components in the vehicle 20 include, but are not limited to, an engine, motor, brakes, transmission, electronic key, power windows, air conditioning, lamps, mirrors, car audio, navigation system, and the like. The ECUs 24 are connected with each other via a network, such as the Controller Area Network (CAN).

The position detector 25 acquires positional information for the vehicle 20. The position detector 25 may include a receiver compliant with the Global Navigation Satellite System (GNSS). The receiver compliant with the GNSS may include, for example, a Global Positioning System (GPS) receiver. In the present embodiment, the vehicle 20 is assumed to be capable of acquiring positional information for the vehicle 20 itself using the position detector 25. The vehicle 20 may transmit the location information for the vehicle 20 itself to the operation management apparatus 10 via the vehicle communication interface 21.

The notification interface 26 includes a display apparatus and/or a speaker provided inside the cabin of the vehicle 20. The notification interface 26 is used to notify the users in the vehicle 20 of information. For example, the notification interface 26 is used to provide notification by images and/or audio that the travel route of the vehicle 20 is changed from the first route to the second route. A known display apparatus, such as a liquid crystal display, organic EL display, inorganic EL display, or plasma display, can be used for the display apparatus. A known typical speaker can be used for the speaker.

The battery 27 is a secondary cell that can be repeatedly charged and discharged. The battery 27 supplies electric power to each component of the vehicle 20. Any secondary cell can be used for the battery 27. The battery 27 can, for example, be a lithium ion battery, a nickel metal hydride battery, a sodium ion battery, a magnesium air battery, a lithium air battery, or a zinc air battery.

(Operation of First Route)

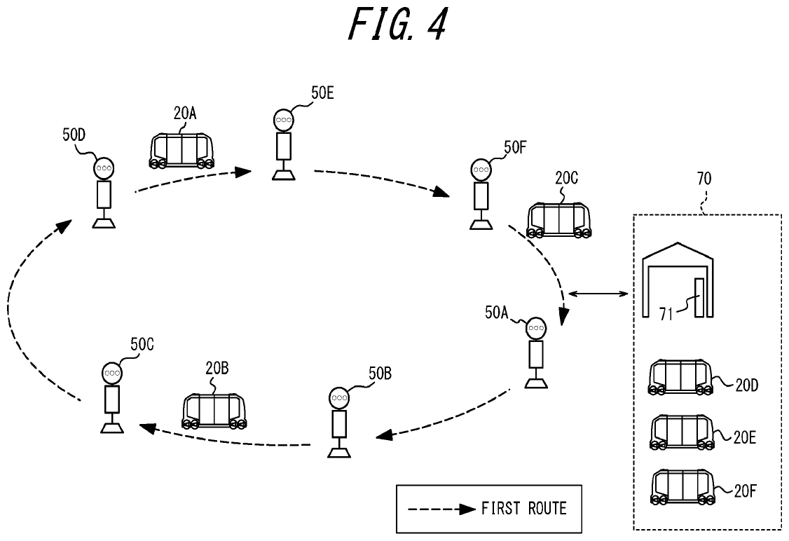

Using FIG. 4, an example of operation of the first route for the plurality of vehicles 20 in the first mode is described. In FIG. 4, the plurality of vehicles 20 includes vehicles 20A, 20B, 20C, 20D, 20E, and 20F. Each vehicle 20 travels along a first route in accordance with an operation schedule. The first route includes a route to circulate along a circular route, a route back and forth along a linear route, and the like. In FIG. 4, the first route is assumed to be a circular route. A plurality of stops 50A, 50B, 50C, 50D, 50E and 50F are provided on the first route as stops 50 for users to board and alight. The vehicle 20 travels sequentially through the stops 50A to 50F. Each vehicle 20 travels to a garage 70 after a predetermined number of laps around the first route (a predetermined number of round trips in the case of a linear route) in accordance with the operation schedule. Upon the vehicle 20 entering the garage 70, predetermined maintenance operations are performed on the vehicle 20, and the battery 27 is charged by a charging apparatus 71.

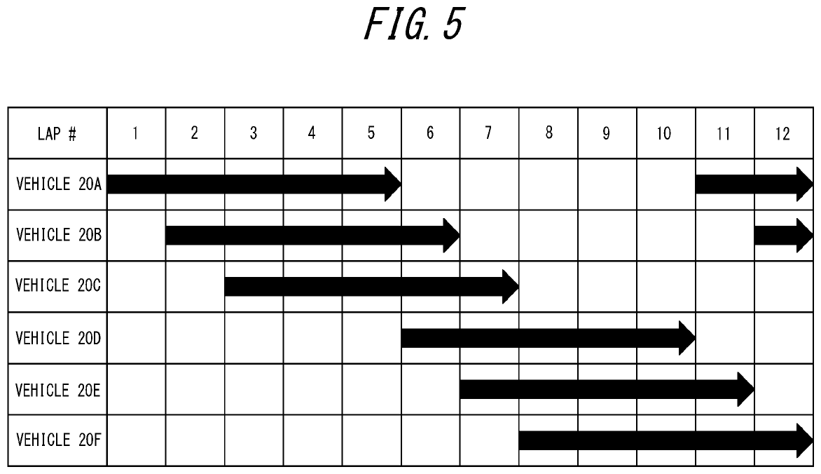

As schematically illustrated in FIG. 5, the vehicles 20 are, for example, dispatched so that at each point in time there are three vehicles 20 traveling along the first route. According to the example in FIG. 4, first, the vehicle 20A is introduced into the first route, and after the vehicle 20A travels one lap on the first route, the vehicle 20B is introduced into the first route. The vehicle 20B may be introduced so as to travel behind the vehicle 20A at a distance corresponding to approximately one-third of one lap on the first route. After the vehicle 20B is introduced into the first route and travels one lap on the first route, the vehicle 20C is further introduced into the first route. The vehicle 20C may be introduced so as to travel behind the vehicle 20B at a distance corresponding to approximately one-third of one lap on the first route. In the example in FIG. 5, the vehicle 20A, the vehicle 20B, and the vehicle 20C each travel five laps around the first route.

On the fifth lap around the first route, the vehicle 20A displays, on the inside and outside of the vehicle 20A, that the stop 50A at the end of the fifth lap will be the final stop. Upon arriving at the stop 50A, the vehicle 20A allows all users to alight, exits the first route, and travels to the garage 70. At the same timing as when the vehicle 20A exits the first route, the vehicle 20D that was waiting in the garage 70 is introduced into the first route and begins to make laps around the first route starting from the stop 50A. Like the vehicle 20A, the vehicle 20B and the vehicle 20C also exit the first route and move to the garage 70 after the fifth lap around the first route. The vehicle 20E and the vehicle 20F are respectively introduced into the first route at the same timing as when the vehicle 20B and the vehicle 20C exit the first route.

Each vehicle 20 charges the battery 27 according to a predetermined schedule while waiting in the garage 70. The vehicles 20 for which charging has ended are introduced into the first route again at a later, predetermined timing and transport users. For example, the vehicle 20A is introduced into the first route again at a timing that corresponds to the 11^{th} lap from the start of travel.

In this way, in the example illustrated in FIGS. 4 and 5, the six vehicles 20A to 20F enable three vehicles 20 to continually transport users along the first route.

(Operation of Vehicles when Setting Second Route)

The demand for passenger transportation on the first route may vary according to time of day, weather, traffic conditions, and other factors. Upon detecting an event indicating a decrease in demand for passenger transportation on the first route, the operation management apparatus 10 can switch some of the vehicles 20 in the first mode traveling the first route to the second mode to reduce the number of vehicles 20 traveling the first route.

Information indicating a decrease in the demand for passenger transportation includes time information. For example, demand for passenger transportation may be high during travel hours for commuters and students during the day and low at other times of the day. Accordingly, the operation management apparatus 10 may use a built-in clock to detect, as an event, that the current time has reached a predetermined time at which use by commuters and students decreases, such as 10 a.m. and 8 p.m.

The operation management apparatus 10 may detect, as an event, the acquisition from the external information source 40 of information indicating a decrease in the expected number of users riding in the vehicles 20 that travel on the first route. The information indicating a decrease in the expected number of users may be information determined based on positional information for mobile phones, surveillance camera information, weather information, and/or information posted on an SNS.

The positional information for mobile phones indicates the geographical distribution of the people who own the phones. In a case in which the density of people in the vicinity of each stop 50 located on the first route is low, the number of users of the passenger transportation service is also estimated to be low. The surveillance camera information can be used to obtain video images of people on the street. Information on the degree of crowding at each location can also be acquired from the surveillance camera information. Weather information includes information on rainy weather, sunny weather, and the like. In the event of rain, the number of users of the passenger transportation service may decrease in the vicinity of facilities for which the number of visitors depends on the weather, such as outdoor facilities. SNS posting information is extracted from information posted on an SNS. The degree of crowding in a specific area can be estimated from text information posted on an SNS, positional information included in photos, and the like.

Upon detecting the occurrence of a predetermined event, the controller 12 selects one vehicle 20 from among the plurality of vehicles 20 that are traveling in the first mode on the first route. The controller 12 determines a second route different from the first route. By transmitting this second route to the selected vehicle 20, the controller 12 switches the travel route of the selected vehicle 20 from the first route to the second route, and switches the selected vehicle 20 to the second mode.

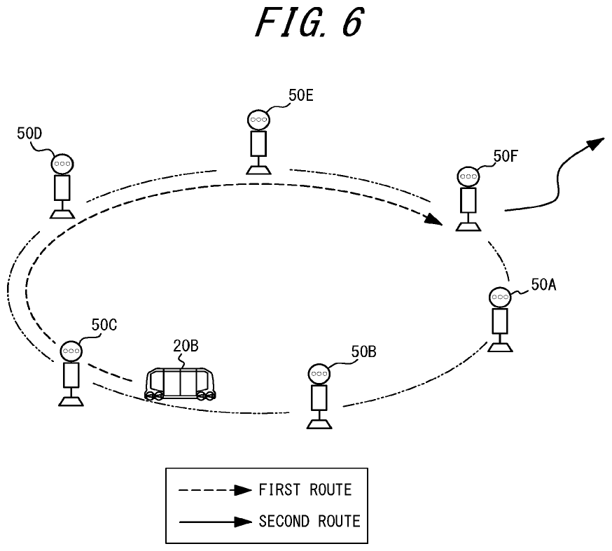

With reference to FIGS. 6 to 9, the method for switching the route will be described below, assuming that the vehicle 20B is selected from among the plurality of vehicles 20 as the vehicle 20 to be switched to the second route. As a precondition, it is assumed that the vehicle 20B was traveling between the stop 50B and the stop 50C when the operation management apparatus 10 determined the second route. It is also assumed that the vehicle 20B is occupied by users who are planning to alight at the stop 50C and the stop 50F. Furthermore, it is assumed that the stop 50E is located in a place such as the vicinity of a station where many people gather. There are multiple variations on the method for switching the route of the vehicle 20B after the operation management apparatus 10 has determined the second route.

(First Example of Route Switching Method)

A first example of the route switching method is described with reference to FIG. 6. After selecting the vehicle 20B, the controller 12 acquires information on the stops 50 at which the users on board the selected vehicle 20B plan to alight. When a user boards the vehicle 20B, the user may register the stop 50 on a terminal in the vehicle 20B. Alternatively, the user may use the portable information terminal 60 to register a stop 50 of the vehicle 20B that the user is riding. The operation management apparatus 10 causes the vehicle 20B to travel on the first route for the users to alight at the respective stops 50 and then switches the travel route of the selected vehicle 20B to the second route. For example, since there are users who will alight at the stop 50C and the stop 50F on the vehicle 20B, the controller 12 causes the vehicle 20B to travel on the first route to the stop 50F and switches the travel route to the second route after the user alights at the stop 50F.

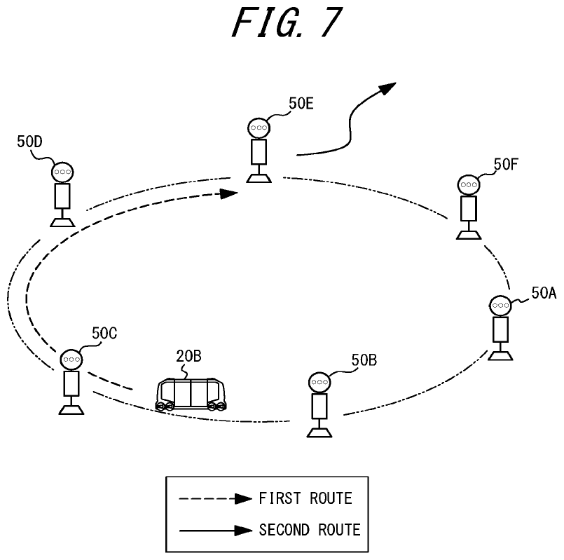

(Second Example of Route Switching Method) A second example of the route switching method is described with reference to FIG. 7. In this example, the stop 50E is a particular stop 50 at which the route of the vehicle 20B switches from the first route to the second route. Particular stops 50 include stops 50 where many users typically board or alight, stops 50 where users can transfer to other modes of transportation, and the like. In the vicinity of the stop 50E, the demand for the on-demand second service is considered to be high.

The vehicle controller 22 of the vehicle 20B, which has received an instruction from the operation management apparatus 10 to switch to the second route, causes the vehicle 20B to travel to the stop 50E according to the instruction from the operation management apparatus 10. While the vehicle controller 22 causes the vehicle 20B to travel to the stop 50E, the vehicle controller 22 uses the notification interface 26 to notify the passengers that the operation on the first route will be terminated at the stop 50E. The vehicle 20 guides users who were planning to alight at the stop 50F, which is located beyond the stop 50E, to transfer to a subsequent vehicle 20. The vehicle 20 may transmit a free transfer ticket to the portable information terminal 60 of each user who was planning to alight at the stop 50F.

(Third Example of Route Switching Method)

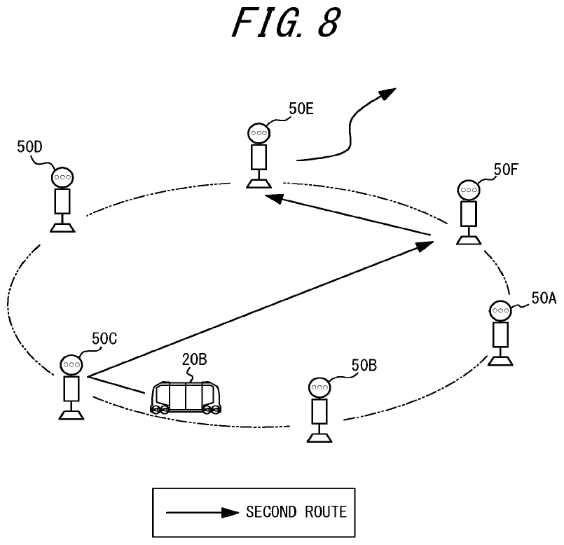

A third example of the route switching method is described with reference to FIG. 8. After selecting the vehicle 20B, the controller 12 acquires information on the stops 50 at which the users on board the selected vehicle 20B plan to alight. The method of acquiring the information on the stops 50 is the same as in the first example. The controller 12 determines the second route to be a route for providing the on-demand second service after allowing the users to alight at the respective stops 50 where the users plan to alight.

In the example in FIG. 8, the vehicle 20B allows users to alight at the stops 50C and 50F, respectively, and then traverses a route to the stop 50E where the need for the on-demand second service is expected to be high. In this case, the route to the stop 50C and the stop 50F may traverse a shorter route, or a route that can be traveled in a shorter time, rather than traversing the first route.

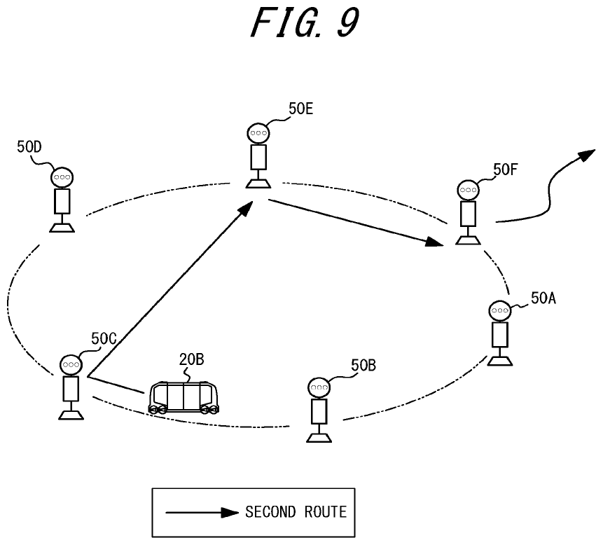

(Fourth Example of Route Switching Method) A fourth example of the route switching method is described with reference to FIG. 9. After selecting the vehicle 20B, the controller 12 acquires information on the stops 50 at which the users on board the selected vehicle 20B plan to alight. The method of acquiring the stops 50 is the same as in the first example. After selecting the vehicle 20B, the controller 12 immediately causes the vehicle 20B to start the second service, i.e., the on-demand passenger transportation service. The controller 12 determines the second route so as to pass through the stops 50C and 50F at which the users who were riding in the vehicle 20B during travel on the first route are to alight.

In the example in FIG. 9, the vehicle 20B allows the users to alight at the stop 50C and then travels to the stop 50E, at which a user of the second service is located. The controller 12 assigns priority to a user who wishes to travel in the direction of the stop 50F as a user of the second service who boards the vehicle 20B at the stop 50E. The controller 12 thus sets a route that traverses the stop 50F as the second route traversed by the vehicle 20B. Accordingly, a user who was riding in the vehicle 20B during travel on the first route can alight at the stop 50F after passing through the stop 50E.

Upon the vehicle 20B being switched from the first route to the second route, only two vehicles 20 are traveling the first route, vehicle 20A and vehicle 20C. In other words, the number of vehicles 20 traveling the first route is reduced in response to a decrease in the number of users using the first route. This improves the usage efficiency of the vehicles 20A and 20C, and enables the vehicle 20B to be effectively used in the second service. Therefore, the overall usage efficiency of the vehicles 20 is improved.

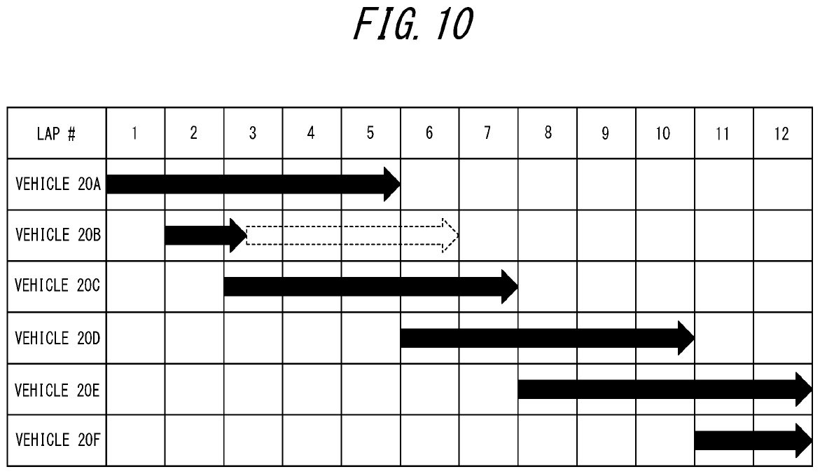

As long as the number of users of the first route does not change, the operation management apparatus 10 can continue to have two vehicles 20 travel the first route after switching the vehicle 20B to the second mode. FIG. 10 illustrates the operation schedules of the respective vehicles 20 traveling the first route before and after the route switch of the vehicle 20B. FIG. 10 is similar to FIG. 5, except that the vehicle 20B exits the first route in the middle of the third lap. In FIG. 10, the portion in which the vehicle 20B exits the first route and drops out from the operating schedule is indicated by a dashed arrow. At the end of the fifth lap by the vehicle 20A after the vehicle 20B exits from the first route, the vehicle 20A exits the first route, and the vehicle 20D is introduced into the first route instead. At the end of the fifth lap by the vehicle 20C, the vehicle 20C exits the first route, and the vehicle 20E is introduced into the first route instead. Furthermore, at the end of the fifth lap by the vehicle 20D, the vehicle 20D exits the first route, and the vehicle 20F is introduced into the first route instead. In this way, two vehicles 20 can always be circulating on the first route.

(Vehicle Operation Management by Controller)

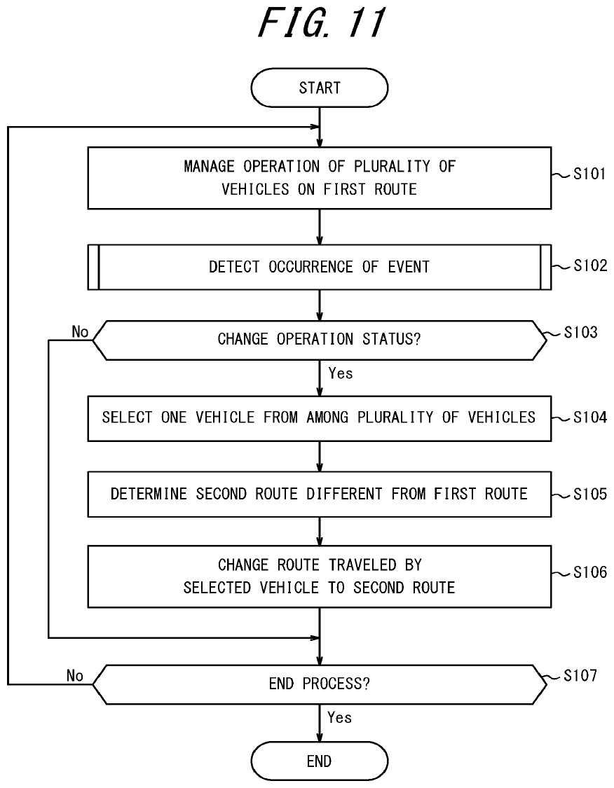

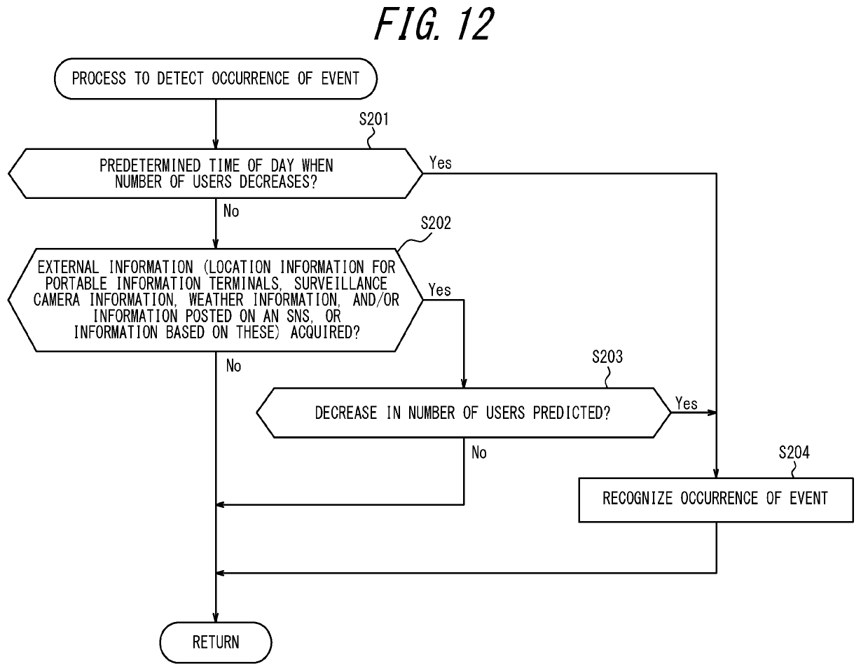

With reference to FIGS. 11 and 12, an operation management method executed by the controller 12 of the operation management apparatus 10 will be described.

The controller 12 manages the operation on the first route of the plurality of vehicles 20 traveling in the first mode and providing the first service (step S101). The operation management apparatus 10 may provide not only vehicles 20 with fixed routes, but also the second service, which is an on-demand passenger transportation service, in parallel. Accordingly, the controller 12 may manage one or more vehicles 20 in the second mode in addition to the vehicles 20A to 20F traveling in the first mode.

The controller 12 detects the occurrence of an event (step S102). An example of procedures for the controller 12 to detect an event will be described with reference to FIG. 12.

The controller 12 has information on the change in the number of users by time of day based, for example, on past ridership by users of the vehicle 20. The information on the change in the number of users by time of day may be stored in the memory 13. The controller 12 determines whether the current time has reached a predetermined time at which the number of users decreases (step S201). In a case in which the predetermined time is reached in step S201 (step S201: Yes), the controller 12 proceeds to the process of step S204. In a case in which the predetermined time has not been reached in step S201 (step S201: No), the controller 12 proceeds to step S202.

In step S202, the controller 12 determines whether external information has been acquired from the external information source 40. The external information may include location information for mobile phones, surveillance camera information, weather information, and/or information posted on an SNS. The external information may include information that is acquired by processing these pieces of information. In a case in which the external information has been acquired in step S202 (step S202: Yes), the controller 12 proceeds to the process of step S203. In a case in which the external information has not been acquired in step S202 (step S202: No), the controller 12 returns to the flowchart of FIG. 11.

In step S203, the controller 12 determines, based on the acquired external information, whether a decrease in the number of users of the passenger transportation service on the first route is predicted. The controller 12 can predict that the number of users will decrease if few people are in the vicinity of the stop 50 on the first route. In a case in which a decrease in the number of users is predicted in step S203 (step S203: Yes), the controller 12 proceeds to step S204. In a case in which a decrease in the number of users is not predicted in step S203 (step S203: No), the controller 12 returns to the flowchart of FIG. 11.

In step S204, the controller 12 recognizes the occurrence of the event. After recognizing the occurrence of the event, the controller 12 returns to the flowchart of FIG. 11.

Returning to the flowchart of FIG. 11, the controller 12 determines whether to change the operation state of any of the vehicles 20 based on the occurrence of the event and the content of the event (step S103). The controller 12 may change the operation state of any of the vehicles 20 in a case in which the number of vehicles 20 in the first mode traveling the first route is greater than a predetermined number, and the occurrence of an event for which the number of users is predicted to decrease is detected in step S102. In a case in which it is determined to change the operation state of any of the vehicles 20 in step S103 (step S103: Yes), the controller 12 proceeds to the process of step S104. In a case in which it is determined not to change the operation state of any of the vehicles 20 in step S103 (step S103: No), the controller 12 proceeds to the process of step S107.

In step S104, the controller 12 selects one vehicle, from among the plurality of vehicles 20 traveling in the first mode, to switch the operation state to the second mode and change the travel route to the second route. The controller 12 may determine the vehicle 20 to switch to the second mode from among the plurality of vehicles 20 traveling the first route by taking into consideration the number of users on board, the current position, the remaining battery level, and the like. For example, the controller 12 may select the vehicle 20 with the lowest number of users on board. For example, the controller 12 may select a vehicle 20 that is traveling toward a stop 50 that is near a location where users of the second service are expected to be, or a stop 50 that is near a railway or other station. For example, the controller 12 may select the vehicle 20 with the highest remaining battery level.

In step S105, the controller 12 determines a second route, different from the first route, on which the vehicle 20 selected in step S104 is to travel. In a case in which the selected vehicle 20 provides the second service, the controller 12 may determine the travel route of the selected vehicle 20 based on a request for vehicle dispatch from one or more users of the second service.

In step S106, the controller 12 transmits, via the communication interface 11, the second route determined in step S105 to the vehicle 20 selected in step S104 and switches the travel route of the selected vehicle 20 to the second route (step S106). In switching the travel route, a switching method selected from a plurality of route switching methods, including any of the methods described using FIGS. 6 to 9, is used. The selected vehicle 20 thereby exits the first route and travels according to the second route. The selected vehicle 20 may subsequently provide the second service according to instructions from the controller 12.

In step S106, the vehicle controller 22 of the selected vehicle 20 receives the second route via the vehicle communication interface 21 and stores the second route in the vehicle memory 23. The vehicle controller 22 controls the ECUs 24 for the vehicle 20 to travel according to the second route. When the route traveled by the selected vehicle 20 is switched, the vehicle controller 22 may use the notification interface 26 to notify the users in the vehicle 20 that the route has been changed. Via the information display apparatus 51 installed at the stop 50 and the portable information terminal 60 of a registered user, the controller 12 of the operation management apparatus 10 may notify the user who is about to board the vehicle 20 that the route has been switched.

In a case in which the operation state is not changed in step S103 (step S103: No), and processing by the controller 12 is not suspended after step S107 (step S107: No), the controller 12 returns to step S101 and repeats the subsequent process. In a case in which an instruction or operation to end the process is provided to the operation management apparatus 10 from an external source (step S107: Yes), the controller 12 ends the process.

With the above-described configuration, the operation management apparatus 10 can allocate some of the vehicles 20 to an on-demand passenger transportation service or the like that traverses the second route in a case in which the number of users of the passenger transportation service operating on the first route is expected to decrease. The transportation efficiency of the vehicles 20 can thereby be improved.

In the above embodiment, the event is related to a decrease in the number of users of the vehicles 20 traveling the first route. However, the event is not limited to indicating a decrease in the number of users of the vehicles 20 traveling the first route. For example, the event may indicate an increase in the number of users of an online passenger transportation service at a particular location. Even in a case in which the number of users of the vehicles 20 traveling the first route is not decreasing, the controller 12 may allocate some of the vehicles 20 to the online passenger transportation service to alleviate congestion of the online passenger transportation service.

While embodiments of the present disclosure have been described based on the drawings and examples, it should be noted that various changes and modifications may be made by those skilled in the art based on the present disclosure. Accordingly, such changes and modifications are included within the scope of the present disclosure. For example, the functions and the like included in each component, step, or the like can be rearranged in a logically consistent manner. Components, steps, or the like may also be combined into one or divided. Although embodiments of the present disclosure have been described focusing on apparatuses, an embodiment of the present disclosure may also be implemented as a method including the steps performed by each component of the apparatuses. An embodiment of the present disclosure may also be implemented as a method or program executed by a processor provided in an apparatus or as a storage medium with the program recorded thereon. These are also encompassed within the scope of the present disclosure.

1. An operation management method, performed by an operation management apparatus, for a plurality of vehicles for passenger transportation, the operation management method comprising:
selecting, upon detecting an occurrence of a predetermined event, one vehicle from among the plurality of vehicles each traveling a predetermined first route;
determining a second route different from the first route; and
switching a route traveled by the selected vehicle from the first route to the second route.

2. The operation management method of claim 1, wherein the predetermined event is that a current time reaches a predetermined time.

3. The operation management method of claim 1, wherein the predetermined event is acquisition of information indicating a decrease in an expected number of users riding in the vehicle traveling the first route.

4. The operation management method of claim 3, wherein the information indicating the decrease in the expected number of users is information determined based on positional information for mobile phones, surveillance camera information, weather information, and/or information posted on a social network service.

5. The operation management method of claim 1, wherein information is acquired, after the vehicle is selected, on respective stops at which users riding in the selected vehicle are planning to alight, and the route traveled by the selected vehicle is switched to the second route after the selected vehicle travels on the first route for the users to alight at the respective stops.

6. The operation management method of claim 1, wherein information is acquired, after the vehicle is selected, on respective stops at which users riding in the selected vehicle are planning to alight, and the second route is determined for the users to alight at the respective stops.

7. The operation management method of claim 1, wherein the first route includes a plurality of stops, and the switching of the route traveled by the selected vehicle from the first route to the second route is performed at a particular stop included in the plurality of stops.

8. The operation management method of claim 1, wherein a request for vehicle dispatch for transportation between a boarding location and an alighting location is acquired, and the second route is determined based on the request.

9. The operation management method of claim 1, wherein the second route is determined to pass through a location with a high passenger transportation need as determined based on positional information for mobile phones, surveillance camera information, weather information, and/or information posted on a social network service.

10. The operation management method of claim 1, wherein the selected vehicle, a portable information terminal of a registered user, and/or an information display apparatus installed at any location on the first route is notified of switching of the route traveled by the selected vehicle from the first route to the second route.

11. An operation management apparatus of a plurality of vehicles for passenger transportation, the operation management apparatus comprising a controller configured to:
select, upon detecting an occurrence of a predetermined event, one vehicle from among the plurality of vehicles each traveling a predetermined first route;
determine a second route different from the first route; and
switch a route traveled by the selected vehicle from the first route to the second route.

12. The operation management apparatus of claim 11, wherein the predetermined event is that a current time reaches a predetermined time.

13. The operation management apparatus of claim 11, wherein the predetermined event is acquisition of information indicating a decrease in an expected number of users riding in the vehicle traveling the first route.

14. The operation management apparatus of claim 13, wherein the information indicating the decrease in the expected number of users is information determined based on positional information for mobile phones, surveillance camera information, weather information, and/or information posted on a social network service.

15. The operation management apparatus of claim 11, wherein the controller acquires information, after selecting the vehicle, on respective stops at which users riding in the selected vehicle are planning to alight, and switches the route traveled by the selected vehicle to the second route after the selected vehicle travels on the first route for the users to alight at the respective stops.

16. An operation management system comprising:
a plurality of vehicles for passenger transportation; and
an operation management apparatus that manages operation of the plurality of vehicles, the operation management apparatus comprising a controller configured to select, upon detecting an occurrence of a predetermined event, one vehicle from among the plurality of vehicles for passenger transportation each traveling a predetermined first route, determine a second route different from the first route, and switch a route traveled by the selected vehicle from the first route to the second route.

17. The operation management system of claim 16, wherein the predetermined event is that a current time reaches a predetermined time.

18. The operation management system of claim 16, wherein the predetermined event is acquisition of information indicating a decrease in an expected number of users riding in the vehicle traveling the first route.

19. The operation management system of claim 18, wherein the information indicating the decrease in the expected number of users is information determined based on positional information for mobile phones, surveillance camera information, weather information, and/or information posted on a social network service.

20. The operation management system of claim 16, wherein the controller acquires information, after selecting the vehicle, on respective stops at which users riding in the selected vehicle are planning to alight, and switches the route traveled by the selected vehicle to the second route after the selected vehicle travels on the first route for the users to alight at the respective stops.
